(19) United States
(12) Patent Application Publication
(10) Pub. No.: US 2026/0246991 A1
(43) Pub. Date: Aug. 20, 2026

(54) A METHOD, APPARATUS AND COMPUTER PROGRAM FOR PROVIDING ACCESSIBILITY OPTIONS

(71) Applicant: Sony Group Corporation, Tokyo (JP)

(72) Inventor: Nigel Stuart MOORE, Newbury Berkshire (GB)

(21) Appl. No.: 19/161,464

(22) PCT Filed: Feb. 15, 2024
(86) PCT No.: PCT/GB2024/050407

§ 371 Date: Sep. 2, 2025

(30) Foreign Application Priority Data
Mar. 16, 2023 (GB) 2303853.2

(51) Int. Cl. H04N 21/422; H04N 21/485; H04N 21/81

(52) U.S. Cl. CPC H04N 21/42204; H04N 21/4856; H04N 21/8106

(57) ABSTRACT

The present disclosure relates to a method of providing a hierarchy of accessibility options for an apparatus. The method comprises the steps of cycling through a plurality of accessibility options in a first level of the hierarchy to select an accessibility option of a first type when receiving a signal indicating a first press of a predetermined key on a control device; and navigating to a second level of the hierarchy to select an accessibility option of a second type when receiving a signal indicating a second press of the predetermined key, the first press and the second press of the predetermined key are of different types, wherein for at least one accessibility option of the plurality of accessibility options in the first level of the hierarchy, a corresponding accessibility option of a same language is navigated to in the second level of the hierarchy.

### BACKGROUND

### Field of the Disclosure

The present technique relates to a method, apparatus and computer program for providing accessibility options in an apparatus for receiving services.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present technique.

Apparatuses for receiving services such as video services on broadband or broadcast are usually provided with accessibility features which allow viewers with impairments such as visually impaired or hearing impaired viewers to enjoy access of the multimedia content to the greatest extent. Known accessibility features related to languages include audio description and specific subtitles for hard of hearing.

Audio Description (AD) is an audio narrative track inserted between the dialogue of a normal audio track, providing linguistic description of the actions, locations, facial expressions, body language, and on-screen text of video programmes, enabling visually impaired people to keep up with visual elements on screen, especially when the visual information is not included in the audio track. Audio description is usually mixed with the main audio track and may be presented in multiple languages.

Specific subtitles (or captioning) for the hard of hearing provide textual description to describe sounds such as “Disco music plays in background” or “Crash as door slams” in addition to the spoken words. Hard of hearing enhancements in subtitles are often displayed in a different colour to the spoken words.

In view of this there is expected to be a desire for current reception devices for receiving services to provide a more efficient and convenient method for the users to select an accessibility option.

It is an aim of embodiments of the present disclosure to at least address this issue.

### SUMMARY

According to the disclosure, there is provided a method of providing a hierarchy of accessibility options for an apparatus. The method comprises the steps of cycling through a plurality of accessibility options in a first level of the hierarchy to select an accessibility option of a first type when receiving a signal indicating a first press of a predetermined key on a control device; and navigating to a second level of the hierarchy to select an accessibility option of a second type when receiving a signal indicating a second press of the predetermined key, the first press and the second press of the predetermined key are of different types, wherein for at least one accessibility option of the plurality of accessibility options in the first level of the hierarchy, a corresponding accessibility option of a same language is navigated to in the second level of the hierarchy.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 describes a service delivery system according to embodiments of the disclosure;

FIG. 2A describes an apparatus of FIG. 1 for accessing services according to embodiments of the disclosure;

FIG. 2B describes a control device of FIG. 2A according to embodiments of the disclosure;

FIG. 3 describes an example scenario in which an audio description track option is selected based on user input to the apparatus of FIG. 1 according to some embodiments of the disclosure;

FIG. 4 shows a 2-D visualization of navigating through an example option array of audio tracks and audio description tracks according to some embodiments of the disclosure;

FIG. 5 shows a flow chart describing a process in the apparatus for providing the option array of audio tracks and audio description tracks of FIG. 4 according to some embodiments of the disclosure;

FIG. 6 shows a 2-D visualization of navigating through an example option array of audio tracks and audio description tracks according to some embodiments of the disclosure;

FIG. 7 shows a flow chart describing a process in the apparatus for providing the option array of audio tracks and audio description tracks of FIG. 6 according to some embodiments of the disclosure;

FIG. 8 describes an example scenario in which a specific subtitles option is selected based on user input to the apparatus of FIG. 1 according to some embodiments of the disclosure;

FIG. 9 shows a 2-D visualization of selecting from an example array of subtitle options and specific subtitle options according to some embodiments of the disclosure;

FIG. 10 shows a flow chart describing a process in the apparatus for providing the array of subtitle options and specific subtitle options of FIG. 9 according to some embodiments of the disclosure;

FIG. 11 shows a 2-D visualization of selecting from an example array of subtitle options and specific subtitle options according to some embodiments of the disclosure; and

FIG. 12 shows a flow chart describing a process in the apparatus for providing the array of subtitle options and specific subtitle options of FIG. 11 according to some embodiments of the disclosure.

### DESCRIPTION OF THE EMBODIMENTS

Referring now to the drawings, wherein like reference numerals designate identical or corresponding parts throughout the several views.

Known control devices for apparatuses have a separate key for audio options (such as choosing between different languages) and another to initiate Audio Description (AD)—a description of what is happening for sight impaired user for example “Robert opens the door and leaves”.

The input mechanism based on two keys may be replaced by one key to reduce control device complexity. The disadvantage is then that a Graphical User Interface (GUI) needs to be displayed to the viewer so that the TV understands what feature is being requested and for the user to be able to request different languages tracks.

For example:
(1) English
(2) French
(3) Welsh
(4) English Audio Description
(5) French Audio Description
(6) Welsh Audio Description

Typically the GUI is navigated by a down key and select key. This can be cumbersome and is not helpful for the sight impaired users because they might not clearly see the GUI.

Assuming the user cannot clearly see the GUI, the options could be spoken by the apparatus and the user would need to react within a few seconds to each option to select the desired audio track.

The present disclosure provides a service delivery system which allows a user, and particularly a sight impaired user, to select an audio accessibility option in an apparatus in an efficient and convenient manner. The selection of audio accessibility option may be performed by using an apparatus, such as a smart TV, a computer, a tablet or a mobile phone, and a single key on a control device such as a remote control.

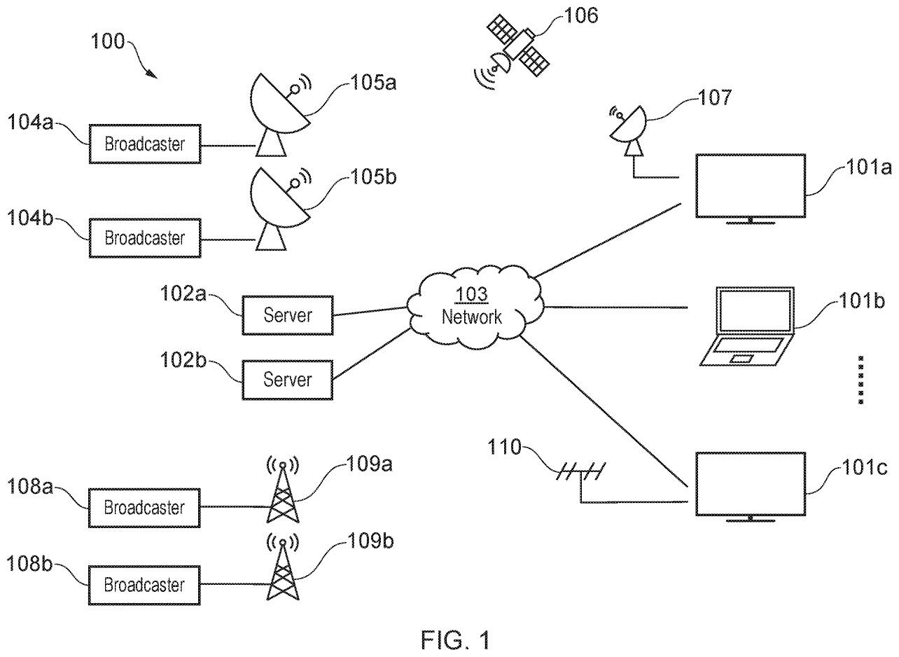

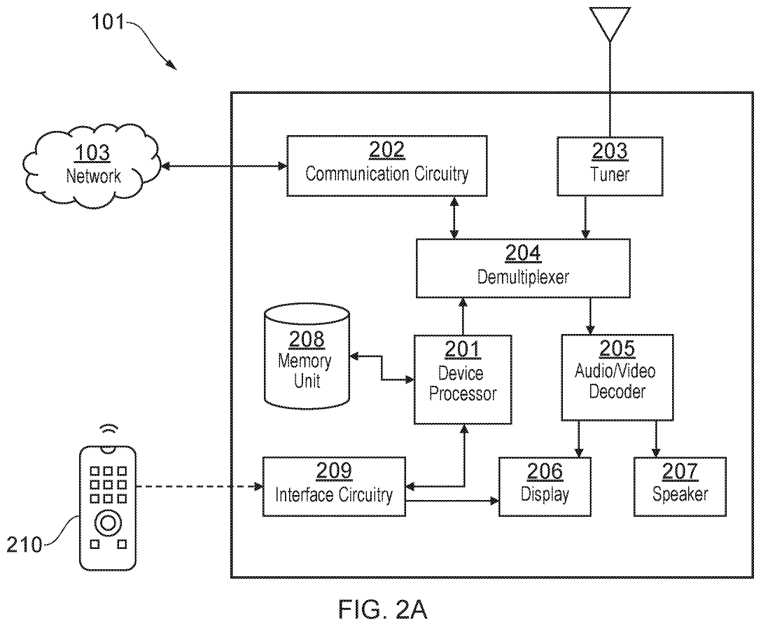

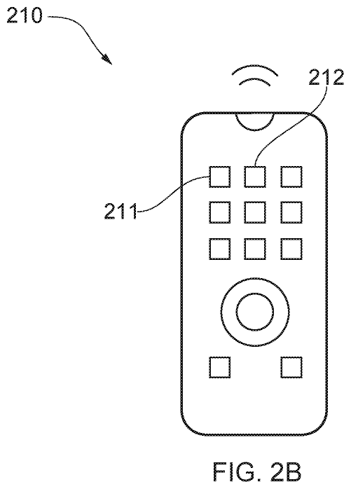

FIG. 1 is a schematic diagram illustrating a service delivery system 100 according to embodiments of the disclosure in which various services are delivered to multiple apparatuses 101a, 101b, 101c. The apparatuses 101a, 101b, 101c may be a smart TV, a personal computer, a laptop, a tablet or a mobile phone capable of receiving the services such as video services, as will be explained later with reference to FIG. 2. Although FIG. 1 shows only three apparatuses, any number of apparatuses is envisaged.

In some embodiments, the service delivery system 100 may involve IP servers 102a, 102b and internet network 103. Apparatuses 101a, 101b, 101c are connected to the IP servers 102, 102b via the network 103 for accessing services, for example, based on Over-the-Top (OTT) technology. In some embodiments, the service delivery system 100 may additionally involve satellite TV broadcasters 104a, 104b, satellite transmitters 105a, 105b, a satellite 106, and a satellite receiver 107. The satellite TV broadcasters 104a, 104b respectively connected to the satellite transmitters 105a, 105b may deliver services by transmitting signals to the satellite 106, which re-transmits the signals to the apparatus 101a via the satellite receiver 107, for example, by using Satellite Direct-to-Home (DTH) technology. In some other embodiments, the service delivery system 100 may further involve terrestrial TV broadcasters 108a, 108b, land-based transmitters 109a, 109b, and a TV aerial 110. The terrestrial TV broadcasters 108a, 108b respectively connected to the land-based transmitters 109a, 109b may deliver services by broadcasting signals, for example, based on Digital Terrestrial Television (DTTV or DTT, or DTTB) technology. The apparatus 101a can then access the services via the TV aerial 110.

The services may be video services delivered by the IP servers 102a, 102b, satellite TV broadcasters 104a, 104b, and terrestrial TV broadcasters 108a, 108b in known video formats, for example, 4K 2160p, 4K 2160PsF, 1080p, 1080i, 1080PsF or 720p. Although FIG. 1 shows only three technologies for delivering video services, i.e.: internet network, satellite transmission, and land-based broadcasting, other technologies for delivering video services is envisaged, for example, cable TV or delivery by 5G or 6G wireless telecommunications technology in a point to point or broadcast mode.

FIG. 2A shows a schematic block diagram illustrating the apparatus 101 according to some embodiments of the disclosure, for accessing services delivered by the IP servers 102a, 102b, satellite TV broadcasters 104a, 104b, or terrestrial TV broadcasters 108a, 108b.

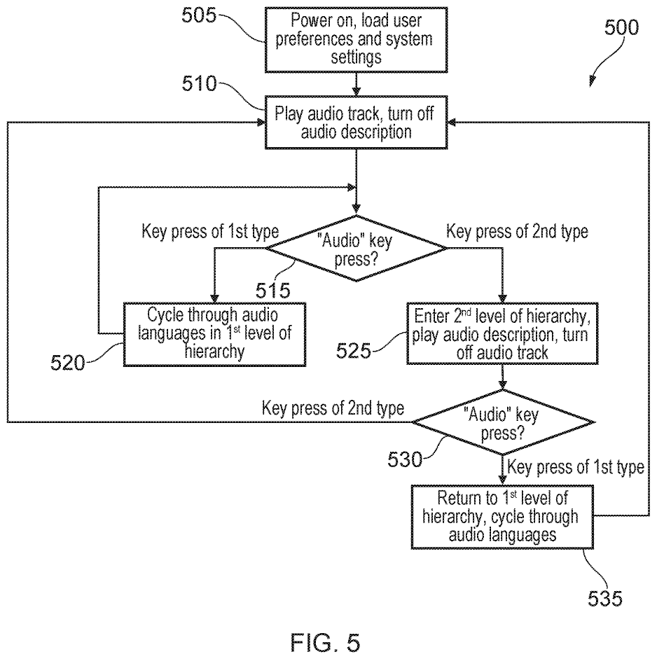

The apparatus 101 comprises a device processor 201. The device processor 201 is embodied as processing circuitry such as a microprocessor or an Application Specific Integrated Circuit or another circuit design and controls the operation of the apparatus 101 using a computer program which is embodied as software code, for example, a receiving software. The apparatus 101 is controlled by the device processor 201 to perform embodiments of the disclosure. A memory unit 208 is connected to the device processor 201 and stores thereon computer-readable instructions which control the device processor 201. According to embodiments of the invention, the memory unit 208 also stores data such as user preferences of the apparatus 101, as will be described later with reference to FIGS. 5, 7, 10 and 12.

The apparatus 101, in embodiments, further comprises communication circuitry 202. The communication circuitry 202 may include a network adapter for connecting the apparatus 101 to the network 103. The network 103 to which the apparatus 101 is connected via the network adapter may be a wide area network, such as the Internet, or a local area network, and the like. The purpose of the network adapter is to receive from the IP servers 102a, 102b communication signals containing services, for example, by means of streaming data.

The apparatus 101, in embodiments, further comprises a tuner 203 and a demultiplexer 204. The tuner 203 receives RF signal such as satellite TV signals through the satellite receiver 107, or terrestrial TV signals via the TV aerial 110 and converts it to communication signals. The demultiplexer 204 is connected to the device processor 201 and transmits communication signals from the communication circuitry 202 or the tuner 203 to the audio and video decoder 205 based on instructions received from the device processor 201.

Additionally connected to the device processor 201 is an audio and video decoder 205 for obtaining audio signals and video signals from the demultiplexer 204. The audio and video decoder 205 may support audio formats, such as MPEG-1 audio, MPEG-2 audio, AC-3 and Enhanced AC-3 audio, DTS Audio, MPEG-4 AAC, MPEG-4 HE AAC, AC-4, MPEG-H Audio, and DTS-UHD Audio. The audio and video decoder 205 may further support known video coding formats, for example, MPEG-2 video, H.264/AVC, MVC, SVC, HEVC, VVC and VC-1. The apparatus 101 may further comprise a display 206 and speakers 207 for respectively play back the video signals and audio signals decoded by the audio and video decoder 205.

Additionally connected to the device processor 201 is interface circuitry 209. The purpose of the interface circuitry 209 is to display a visual interface in the display 206 and to receive user inputs, such as from a touch screen of the display 206, or from an external control device 210, thereby allowing a user to enter commands to the apparatus 101, or to configure the settings of the apparatus 101.

FIG. 2B is a schematic diagram illustrating a control device 210 for controlling the apparatus 101 according to embodiments of the disclosure. The control device may be a remote control comprising a first predetermined key, for example, an audio key 211, to allow a user to access and select the audio accessibility options. In some embodiments, the control device may comprise a second predetermined key, for example, a subtitle key 212, to allow the user to access and select the subtitle options. The control device may operate from computer executable code stored in memory of a touchscreen device such as tablet or mobile phone. Remote control functionality may be provided in the form of an application; subtitle key 212 may be virtual key on a touchscreen. The application may be provided to operate many or all services running on apparatus 101 and as such may control the operating system of apparatus 101. In some embodiments, the application may be provided to control one or more applications that are pre-installed or downloaded to apparatus 101, such as a streaming applications from different providers on a television.

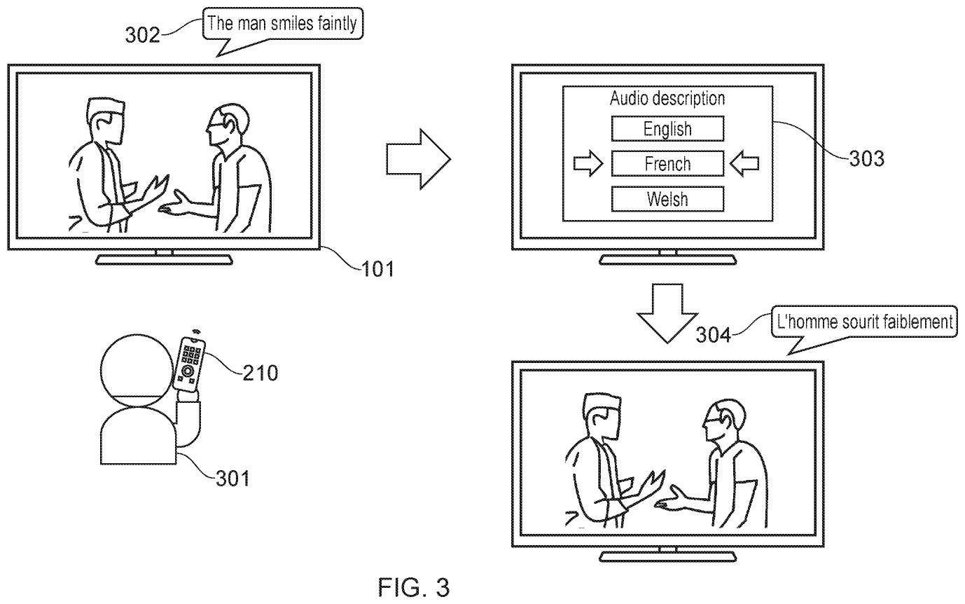

FIG. 3 describes an example scenario in which an audio description track option is selected based on user input to the apparatus 101 according to some embodiments of the disclosure. A user such as a visually impaired user may need to turn on the audio description option of the apparatus 101 after switching to a TV programme or a movie, thereby changing the audio track to the audio description track 302. If the TV programme or movie content has multiple audio description tracks presented in different languages, the user may wish to select an audio description in his or her preferred language. In FIG. 3, a user such as a visually impaired user 301 initially turns on the apparatus or switches to a TV programme where a default audio track is played on the speaker 207, he or she may decide to activate the audio description feature of a desired language. According to embodiments of the disclosure, the user 301 operates the control device 210 with a second type of press on a predetermined key, for example, the “Audio” key 211 as illustrated in FIG. 2B. The single “Audio” key 211 may function as a toggle switch, allowing the user to cycle through different languages available for the TV programme, for example (1) English>(2) French>(3) Welsh, when a first type of press is applied. If the sight impaired user 301 is French and does not understand English well, the user 301 initially hears English audio and therefore decides to change the language by pressing the “Audio” key 211. The user 301 then hears French, but wishes for the audio description, he or she then apply the second type of press on the “Audio” key 211 on the control device 210 and the apparatus 101 switches to an audio description track in French 304.

The first type of key press and the second type of key press are of different types, which may be selected from different manners of pressing the predetermined key, such as short press, long press, double press, extremely long press, and even a pattern or a sequence combining any of the above. Double press for example may comprise a first press followed by a second press within a first interval, and without a third press within a second interval. First interval may be of the order of 0.25-1.00 seconds, but the disclosure is not so limited. According to embodiments of the disclosure, the first type of key press is a short press of the predetermined key and the second type of press is a long press of the predetermined key. A long press of the predetermined key on the control device may generate multiple bursts of the same IR code of the predetermined key. In some embodiments, Bluetooth control devices are used. In response to a long press, a Bluetooth control device may transmit a particular message code for the predetermined key for multiple times. In some embodiments, virtual keys on touch screen devices are used instead of physical buttons. A long press may be detected if the train of bursts received by the apparatus lasts longer than a predetermined time threshold, for example, 1 second. Similarly, a short press may be detected if the train of bursts lasts shorter than the predetermined time threshold. In some embodiments, a control device may comprise circuitry which detects the duration of the press and modifies the code or message code according to an algorithm-such that a long press sends a different code rather than relying on the receiver to detect a repeat of the same code.

In such a way, no GUI is then needed to be displayed on the display 206, and only a single key is required for the sight impaired user to operate the selection of audio description and audio language, thereby allowing a user, especially a sight impaired user, to select an audio accessibility option in an apparatus in an efficient and convenient manner. In some embodiments, it will be beneficial to have a GUI 303 shown on the display 206 for the user who is not sight impaired also. In this way they can see what audio tracks are available and which is currently selected.

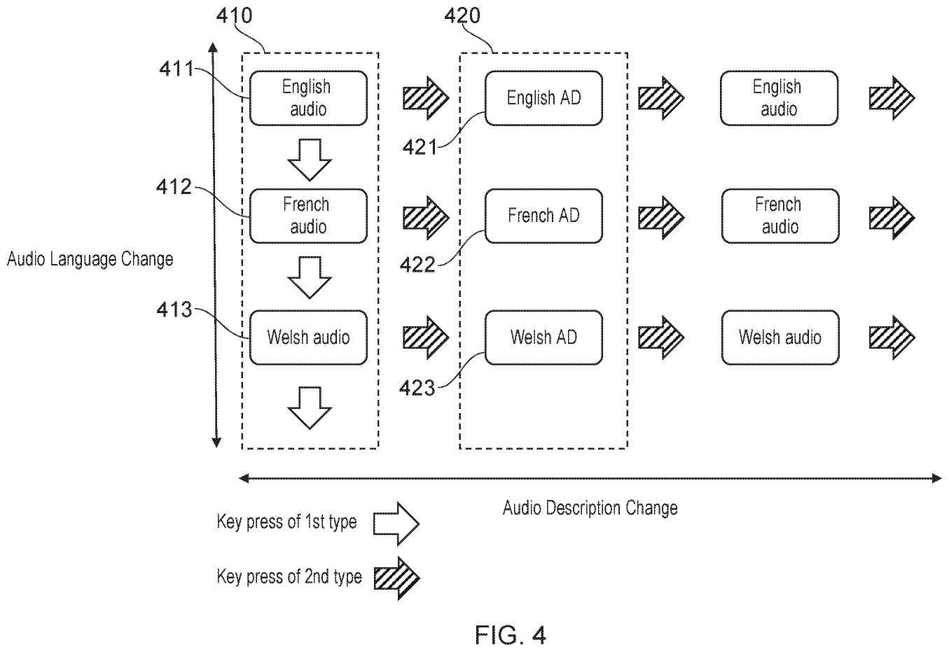

FIG. 4 illustrates a 2-D visualization of navigating through an example option array of audio tracks and audio description tracks according to some embodiments of the disclosure. In this way a first type of accessibility option such as audio tracks 411, 412, 413 are arranged in a first level of hierarchy 410 and a second type of accessibility option 421, 422, 423 such as corresponding audio description language tracks are arranged in a second level of hierarchy 420, although not all languages tracks may have a corresponding audio description language track in the same language.

The user may cycle through a list of audio track options in different languages in the first level of the hierarchy with the first type of presses on the “Audio” key (along a virtual Y axis). After confirming the audio track option, subsequent application of the second type of press will activate a virtual X axis along which related audio description track option can be selected in the second level of the hierarchy. A subsequent application of the second type of press will cycle to the next level of the hierarchy where a further type of accessibility option such as an alternative audio description option can be selected, or returning to the first level of the hierarchy if a further type of accessibility option is not available. In some embodiments, the X axis and Y axis in FIG. 4 may be represented in the GUI for the non-sight impaired user. In some embodiments, the representation of the virtual axes may be reversed such that the X axis represents audio track whereas the Y axis represents the audio description tracks.

FIG. 5 illustrates a flow chart 500 describing a computerized process in the apparatus 101 for providing the option array of audio tracks and audio description tracks of FIG. 4 according to some embodiments of the disclosure. Process 500 may begin at step 505, where the apparatus 101 is powered on, and user preferences (such as preferred language of audio track and audio description, or whether audio description should be turned on by default) stored in the internal memory unit 208 is loaded.

At step 510, the apparatus 101 accesses service and the default audio track is played on the speaker 207. The audio description option may initially be turned off by default. In some embodiments, the audio track and audio description options may be set according to the user preferences obtained in step 505.

At step 515, the process waits until the user has pressed a predetermined key for selecting audio accessibility, such as an “Audio” key, and determines whether the first type or second type of press is applied by the user. In some embodiments, the first type of press is a short press of the “Audio” key on the control and the second type of press is a long press of the “Audio” key. In the event that the first type of press of the “Audio” key is detected, the process moves to step 520, where the apparatus cycles through the audio tracks available for the TV programme or movie content in the first level of the hierarchy and selects the next audio track. The process then returns to step 515 to wait for another key press.

Returning to step 515, in the event that a second type of press of the “Audio” key is detected, the process moves to step 525, where the apparatus navigates to the second level of the hierarchy, turns on the audio description option and plays the audio description track on the speaker 207 which is in the same language as the previously selected audio track.

The process then moves to step 530, where the process waits until the user presses the “Audio” key again, and determines whether the first type or the second type of press is applied by the user. In the event that the first type of press of the “Audio” key is detected, the process moves to step 535, where the apparatus navigates to the first level of the hierarchy, cycles through the audio tracks available for the TV programme or movie and selects the next audio track. The process then returns to step 510 where the selected audio track is played on the speaker 207, whereas the audio description track option will be turned off.

Returning to step 530, in the event that the second type of press of the “Audio” key is detected, the process also returns to step 510, where the apparatus returns to the first level of the hierarchy, turns off the audio description option and plays the previously selected audio track on the speaker 207.

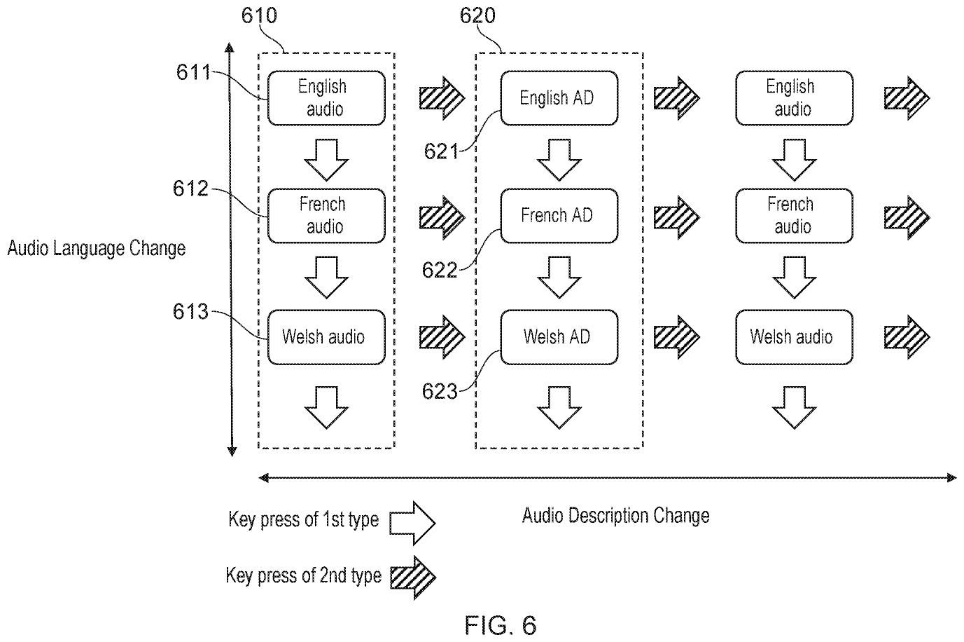

FIG. 6 shows a 2-D visualization of navigating through an example option array of audio tracks and audio description tracks according to some embodiments of the disclosure. In this way a first type of accessibility options such as audio tracks 611, 612, 613 are arranged in a first level of hierarchy 610 and a second type of accessibility options 621, 622, 623 such as corresponding audio description language tracks are arranged in a second level of hierarchy 620, although not all languages tracks may have a corresponding audio description language track in the same language.

The user may cycle through a list of audio track options in different languages with the first type of presses of the “Audio” key (along a virtual Y axis). After confirming the audio track option, subsequent application of the second type of press will activate a virtual X axis along which related audio description track option can be selected. In some embodiments, the X axis and Y axis may be represented in the GUI for the non-sight impaired user. In some embodiments, the representation of the virtual axes may be reversed such that the X axis represents audio track whereas the Y axis represents the audio description tracks.

As a variant of the embodiments described in FIG. 4, after the second type of press to get into the second level of the hierarchy and selecting the corresponding audio description option in FIG. 6, further application of the first type of presses will cycle through audio description language options directly in the second level of the hierarchy. This simplifies the process of switching between audio description language options and provides convenience by saving the need of returning to the first level of hierarchy, then cycling to the audio track in the desired language, and finally entering the second level of the hierarchy to activate the audio description language option in the desired language. In some embodiments, a subsequent application of the second type of press at the second level of the hierarchy will cycle to the next level of the hierarchy, where an additional type of accessibility options, such as an alternative audio description track, can be selected. If a further level of accessibility options is not available in the hierarchy, the process will return to the first level of the hierarchy.

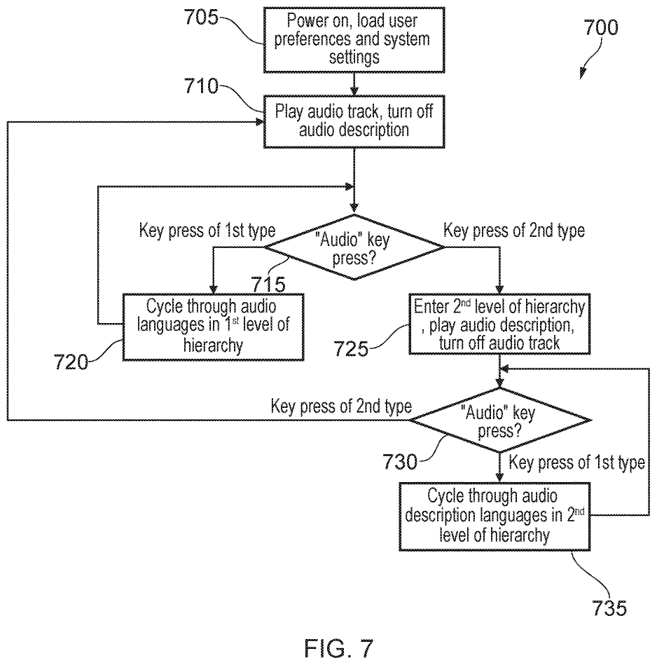

FIG. 7 illustrates a flow chart describing a computerized process in the apparatus 101 for providing the option array of audio tracks and audio description tracks of FIG. 6 according to some embodiments of the disclosure. Process 700 begins at step 705, where the apparatus 101 is powered on, and user preferences (such as preferred language of audio track and audio description, or whether audio description should be turned on by default) stored in the internal memory unit 208 is loaded.

At step 710, the apparatus 101 accesses service and the default audio track is played on the speaker 207. The audio description option may initially be turned off by default. In some embodiments, the audio track and audio description options may be set according to the user preferences obtained in step 705.

At step 715, the process waits until the user has pressed a predetermined key for selecting audio accessibility, such as an “Audio” key, and determines whether the first type or the second type of press is applied by the user. In some embodiments, the first type of press is a short press of the “Audio” key on the control device and the second type of press is a long press of the “Audio” key. In the event that the first type of press of the “Audio” key is detected, the process moves to step 720, where the apparatus cycles through the audio tracks available for the TV programme or movie content in the first level of the hierarchy and selects the next audio track in the second level of the hierarchy. The process then returns to step 715 to wait for another key press.

Returning to step 715, in the event that a second type of press of the “Audio” key is detected, the process moves to step 725, where the apparatus enters the second level of the hierarchy, turns on the audio description option and plays the audio description track on the speaker 207 which is in the same language as the previously selected audio track.

The process then moves to step 730, where the process waits until the user presses the “Audio” key again, and determines whether the first type or the second type of press is applied by the user. In the event that the first type of press of the “Audio” key is detected, the process moves to step 735, where the apparatus cycles through the audio tracks available for the TV programme or movie, and selects the next audio track. The process then returns to step 730 where the apparatus remains in the second level of the hierarchy and waits for another key press.

Returning to step 730, in the event that the second type of press of the “Audio” key is detected, the process also returns to step 710, where the apparatus returns to the first level of the hierarchy, turns off the audio description option and plays the previously selected audio track on the speaker 207.

According to some embodiments of the disclosure, it is advantageous to use common functionality for accessibility functions, not least for ease of explanation to all users irrespective of accessibility requirement. For example, a user may be hard of hearing and subtitles is preferred when watching a TV programme or movie. Similar to audio tracks and audio description tracks, subtitles options are provided in multiple languages. Apart from audio description, other accessibility functions that may apply common functionality according to embodiments of the disclosure include captioning, signing, audio (spoken) captions, specific subtitles for the hard of hearing, voice guide, screen reader, and voice control. As such, a service delivery system can be provided which allows a user, and particularly a hearing impaired user, to select a visual accessibility option in an apparatus in an efficient and convenient manner.

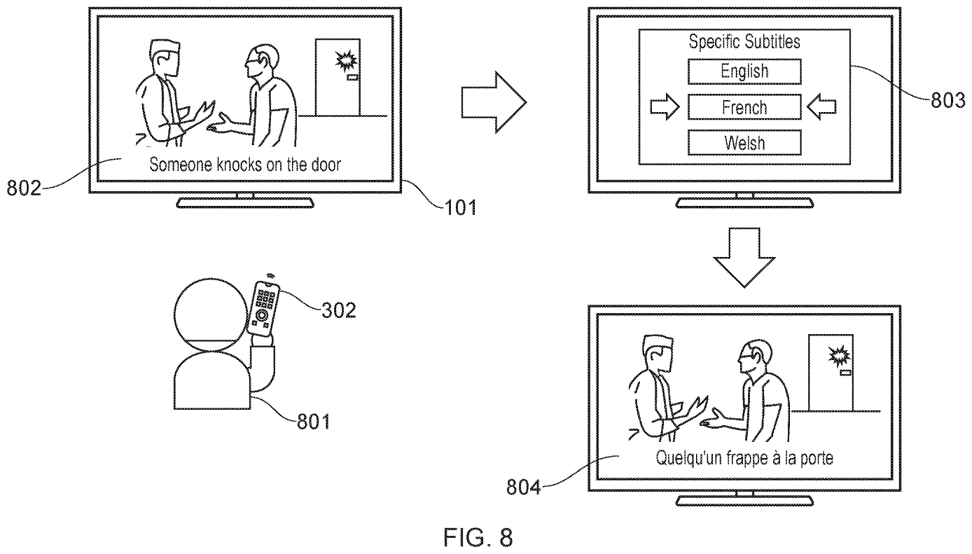

FIG. 8 describes an example scenario in which a specific subtitles option is selected based on user input to the apparatus 101 according to embodiments of the disclosure. A user such as one suffering from hard of hearing may need to turn on the subtitle option or the specific subtitle option of the apparatus 101 after switching to a TV programme or movie. If the TV programme or movie content has multiple subtitles files presented in different languages, the user may wish to select a subtitle file in his or her preferred language. In FIG. 8, a user such as a hearing impaired user 801 initially turns on the apparatus or switches to a TV programme where a default subtitle file is displayed, he or she may decide to activate the specific subtitles feature of a desired language. According to embodiments of the disclosure, the user 801 operates the control device 210, such as a remote control, with the second type of press of a predetermined key, for example, the “Subtitle” key 212 as illustrated in FIG. 2B. The single “Subtitle” key 212 may function as a toggle switch, allowing the user to cycle through different subtitle languages available for the TV programme, for example (1) English>(2) French>(3) Welsh, when a first type of press is applied. If the hearing impaired user 801 is French and does not understand English well, the user 801 initially sees English subtitles and therefore decides to change the language by pressing the “Subtitle” key 212. The user 801 then sees French subtitles, but wishes for the specific subtitles, he or she then apply the second type of press on the “Subtitle” key 212 on the control device 210 and the apparatus 101 switches to a specific subtitle file in French 804.

In such a way, only a single key is required for the sight impaired user to operate the selection of subtitle options and specific subtitle options, thereby allowing a user, especially a hearing impaired user, to select a visual accessibility option in an apparatus in an efficient and convenient manner. In some embodiments, it will be beneficial to have a GUI, such as an accessibility options menu, shown on the display 206 for the user to see what visual accessibility options are available and which is currently selected.

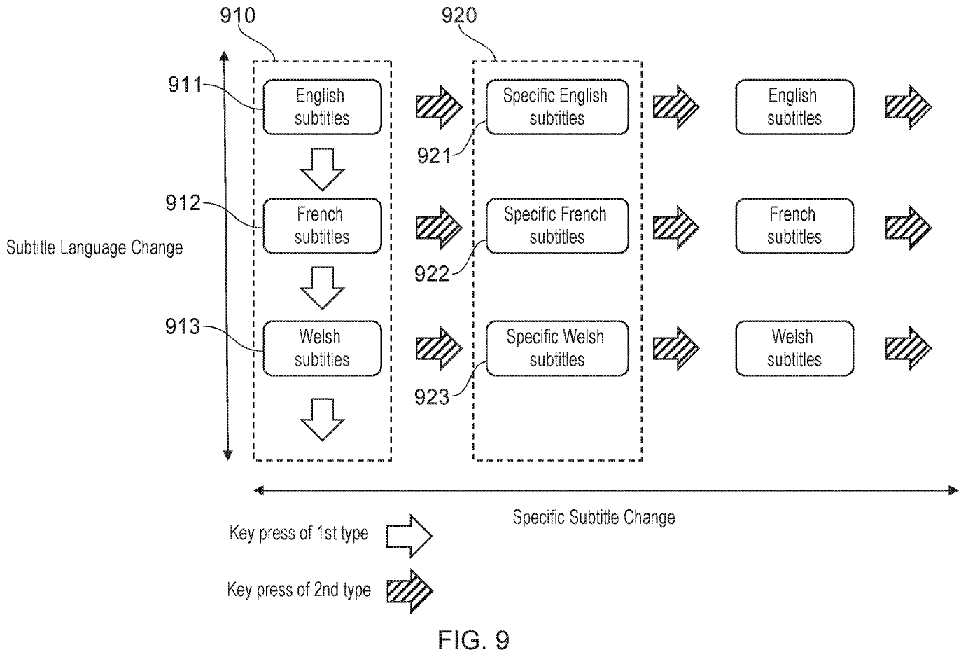

FIG. 9 illustrates a 2-D visualization of navigating through an example option array of subtitle options and specific subtitle options according to some embodiments of the disclosure. In this way, a first type of accessibility options such as subtitle options 911, 912, 913 are arranged in a first level of hierarchy 910 and a second type of accessibility options such as corresponding specific subtitle options 921, 922, 923 are arranged in a second level of hierarchy 920, although not all subtitle options may have a corresponding specific subtitle option in the same language.

The user may cycle through a list of subtitle options in different languages in the first level of the hierarchy with the first type of presses on the “Subtitle” key (along a virtual Y axis). After confirming the subtitle option, subsequent application of the second type of press will activate a virtual X axis along which related specific subtitle options can be selected in the second level of the hierarchy. A subsequent application of the second type of press will cycle to the next level of the hierarchy where a further type of accessibility option such as an alternative specific subtitle option can be selected, or returning to the first level of the hierarchy if a further type of accessibility option is not available. In some embodiments, the X axis and Y axis may be represented in the GUI shown on the display 206 for the hearing impaired user. In some embodiments, the representation of the virtual axes may be reversed such that the X axis represents subtitle options whereas the Y axis represents the specific subtitle options.

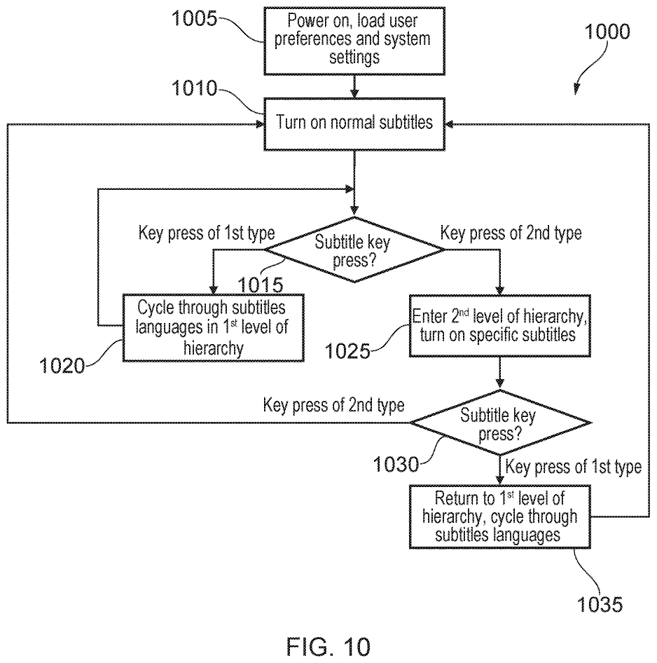

FIG. 10 illustrates a flow chart describing a computerized process in the apparatus 101 for providing the option array of subtitle options and specific subtitle options of FIG. 9 according to some embodiments of the disclosure. Process 1000 begins at step 1005, where the apparatus 101 is powered on, and user preferences (such as preferred language of subtitle option and specific subtitle option, or whether specific subtitle option should be turned on by default) stored in the internal memory unit 208 is loaded.

At step 1010, the apparatus 101 accesses service and the default subtitle option is played on the display 206. The specific subtitle option may initially be turned off by default. In some embodiments, the subtitle option and specific subtitle option options may be set according to the user preferences obtained in step 1005.

At step 1015, the process waits until the user has pressed a predetermined key for selecting vision accessibility, such as a “Subtitle” key, and determines whether a the first type or second type of press is applied by the user. In some embodiments, the first type of press is a short press of the “Subtitle” key on the control and the second type of press is a long press of the “Subtitle” key. In the event that a first type of press of the “Subtitle” key is detected, the process moves to step 1020, where the apparatus cycles through the subtitle options available for the TV programme or movie content in the first level of the hierarchy and selects the next subtitle option. The process then returns to step 1015 to wait for another key press.

Returning to step 1015, in the event that a second type of press of the “Subtitle” key is detected, the process moves to step 1025, where the apparatus navigates to the second level of the hierarchy, turns on the specific subtitle option and displays the specific subtitle option on the display 206 which is in the same language as the previously selected subtitle option.

The process then moves to step 1030, where the process waits until the user presses the “Subtitle” key again, and determines whether the first type or second type of press is applied by the user. In the event that the first type of press of the “Subtitle” key is detected, the process moves to step 1035, where the apparatus returns to the first level of the hierarchy, cycles through the subtitle options available for the TV programme or movie content and selects the next subtitle option. The process then returns to step 1010 where the selected subtitle option is displayed on the display 206, whereas the specific subtitle option will be turned off.

Returning to step 1030, in the event that a second type of press of the “Subtitle” key is detected, the process also returns to step 1010, where the apparatus returns to the first level of the hierarchy, turns off the specific subtitle option and displays the previously selected subtitle option on the display 206.

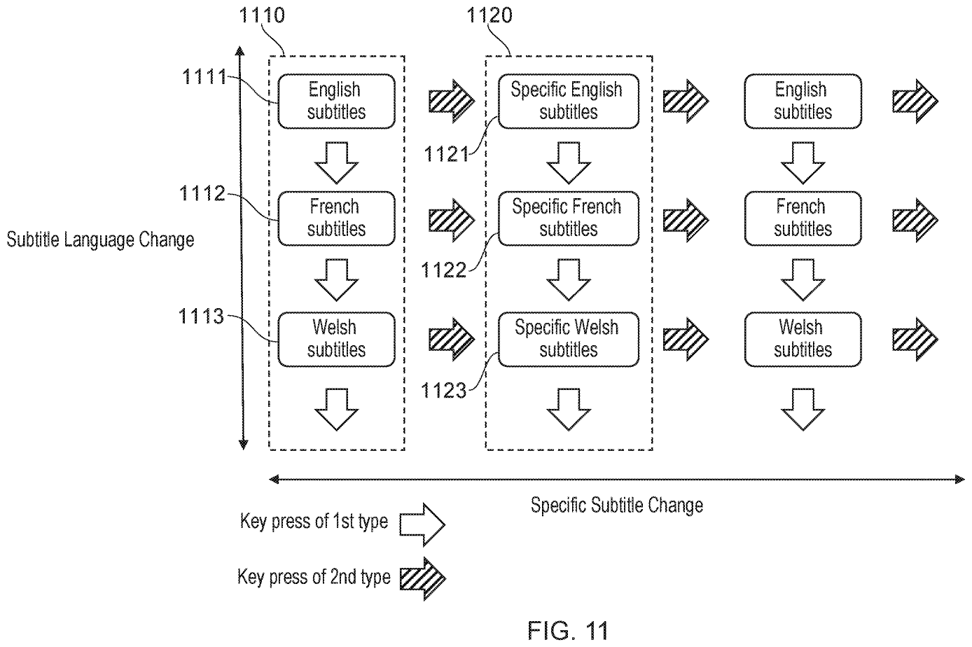

FIG. 11 illustrates a 2-D visualization of navigating through an example option array of subtitle options and specific subtitle options according to some embodiments of the disclosure. In this way, a first type of accessibility options such as subtitle options 1111, 1112, 1113 are arranged in a first level of hierarchy 1110 and a second type of accessibility options such as corresponding specific subtitle options 1121, 1122, 1123 are arranged in a second level of hierarchy 1120, although not all subtitle options may have a corresponding specific subtitle option in the same language.

The user may cycle through a list of subtitle options in different languages with the first type of presses on the “Subtitle” key (along a virtual Y axis). After confirming the subtitle option, subsequent application of the second type of press will activate a virtual X axis along which related specific subtitle options can be selected. In some embodiments, the X axis and Y axis may be represented in the GUI shown on the display 206 for the hearing impaired user. In some embodiments, the representation of the virtual axes may be reversed such that the X axis represents subtitle options whereas the Y axis represents the specific subtitle options.

As a variant of the embodiments described in FIG. 9, after the second type of press to get into the second level of the hierarchy for selecting a specific subtitle option in FIG. 11, further application of the first type of presses will cycle through specific subtitle options directly in the second level of the hierarchy. This simplifies the process of switching between specific subtitle options and provides convenience by saving the need of returning to the first level of hierarchy, then cycling to the subtitle option in the desired language, and finally entering the second level of the hierarchy to activate the specific subtitle option in the desired language. In some embodiments, a subsequent application of the second type of press at the second level of the hierarchy will cycle to the next level of the hierarchy, where an additional type of accessibility options, such as an alternative specific subtitle option, can be selected. If a further level of accessibility options is not available in the hierarchy, the process will return to the first level of the hierarchy.

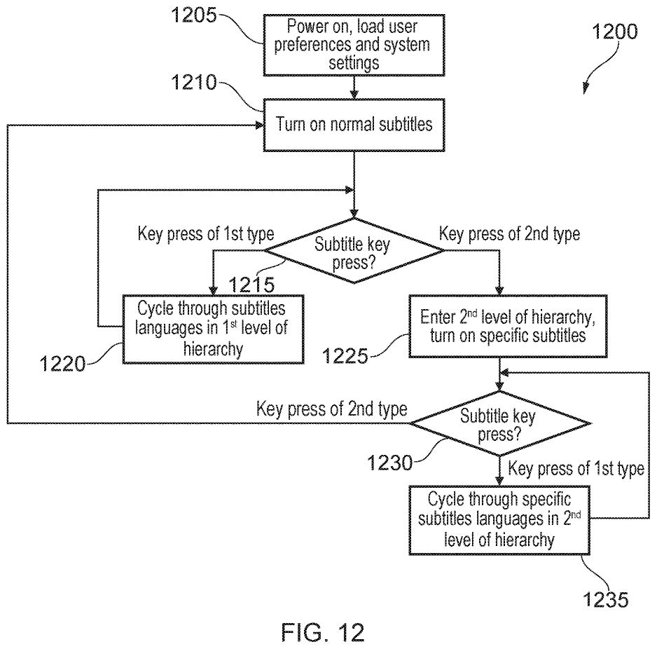

FIG. 12 illustrates a flow chart describing a computerized process in the apparatus 101 for providing the option array of subtitle options and specific subtitle options of FIG. 11 according to some embodiments of the disclosure. Process 1200 begins at step 1205, where the apparatus 101 is powered on, and user preferences (such as preferred language of subtitle option and specific subtitle option, or whether specific subtitle option should be turned on by default) stored in the internal memory unit 208 is loaded.

At step 1210, the apparatus 101 accesses service and the default subtitle option is displayed on the display 206. The specific subtitle option may initially be turned off by default. In some embodiments, the subtitle option and specific subtitle option options may be set according to the user preferences obtained in step 1005.

At step 1215, the process waits until the user has pressed a predetermined key for selecting vision accessibility, such as a “Subtitle” key, and determines whether the first type or the second type of press is applied by the user. In some embodiments, the first type of press is a short press of the “Audio” key on the control device and the second type of press is a long press of the “Audio”. In the event that the first type of press of the “Subtitle” key is detected, the process moves to step 1220, where the apparatus cycles through the subtitle options available for the TV programme or movie content in the first level of the hierarchy and selects the next subtitle option. The process then returns to step 1215 to wait for another key press.

Returning to step 1215, in the event that second type of press of the “Subtitle” key is detected, the process moves to step 1225, where the apparatus enters the second level of the hierarchy, turns on the specific subtitle option and displays the specific subtitle option on the display 206 which is in the same language as the previously selected subtitle option.

The process then moves to step 1230, where the process waits until the user presses the “Subtitle” key again, and determines whether the first type or the second type of press is applied by the user. In the event that the first type of press of the “Subtitle” key is detected, the process moves to step 1235, where the apparatus cycles through the subtitle options available for the TV programme or movie content and selects the next subtitle option in the second level of the hierarchy,. The process then returns to step 1230 where the apparatus remains in the second level of the hierarchy and wait for another key press.

Returning to step 1230, in the event that the second type of press of the “Subtitle” key is detected, the process also returns to step 1210, where the apparatus navigates to the first level of the hierarchy, turns off the specific subtitle option and displays the previously selected subtitle option on the display 206.

In some example scenarios, a user may be both sight impaired and hard of hearing. Therefore the activation of the audio description (and indeed hard of hearing subtitle) may be signalled to the user by haptic feedback such as the control device emitting a buzz or vibration. In some embodiments, the apparatus could be control to output a short burst at a particular frequency, in particular a low frequency. Depending on the extent of their impairments, activating both audio description and hard of hearing subtitles may be helpful to the user. Unifying the functionality of control key presses with respect to accessibility options may be advantageous, for example in assisting users with familiarity of operation for accessibility options.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent embodiments of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors. The different units, circuitry and/or processors may be physically distributed across any distance. The disclosed embodiments may also be implemented based on processing and storage units located in a remote system, such as in the Cloud.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present technique can generally be described by the following numbered clauses:
1. A method of providing a hierarchy of accessibility options for an apparatus, comprising the steps of:
cycling through a plurality of accessibility options in a first level of the hierarchy to select an accessibility option of a first type when receiving a signal indicating a first press of a predetermined key on a control device; and
navigating to a second level of the hierarchy to select an accessibility option of a second type when receiving a signal indicating a second press of the predetermined key, the first press and the second press of the predetermined key are of different types,
wherein for at least one accessibility option of the plurality of accessibility options in the first level of the hierarchy, a corresponding accessibility option of a same language is navigated to in the second level of the hierarchy.
2. The method according to clause 1, wherein the plurality of accessibility options in the first level of the hierarchy are in different languages.
3. The method according to clause 1, wherein the plurality of accessibility options in the second level of the hierarchy are in different languages.
4. The method according to clause 1, further comprising the step of:
selecting, upon navigating to the second level of the hierarchy, an accessibility option in the second level of the hierarchy which is in the same language of the previously selected accessibility option in the first level of the hierarchy.
5. The method according to clause 1, further comprising the step of:
returning to the first level of the hierarchy to select an accessibility option of the same language in the first level when a press of first type is applied to the predetermined key at the second level of the hierarchy; and
cycling through the plurality of accessibility options in the first level of the hierarchy.
6. The method according to clause 1, further comprising the step of:
cycling through the plurality of accessibility options in the second level when a press of first type is applied to the predetermined key at the second level of the hierarchy.
7. The method according to clause 6, further comprising the step of:
returning to the first level of the hierarchy to select an accessibility option of the same language in the first level when a press of second type is applied to the predetermined key at the second level of the hierarchy.
8. The method according to any of clauses 1 to 7, wherein the plurality of accessibility options in the first level of the hierarchy are audio track options, and the plurality of accessibility options in the second level are audio description track options.
9. The method according to any of clauses 1 to 7, wherein the plurality of accessibility options in the first level are subtitle options, and the plurality of accessibility options in the second level are specific subtitle options.
10. A computer program product comprising computer readable instructions which, when loaded onto a computer, configure the computer to perform a method according to any preceding clause.
11. An apparatus, comprising circuitry configured to:
cycle through a plurality of accessibility options in a first level of the hierarchy to select an accessibility option of a first type when receiving a signal indicating a first press of a predetermined key on a control device; and
navigate to a second level of the hierarchy to select an accessibility option of a second type when receiving a signal indicating a second press of the predetermined key,-the first press and the second press of the predetermined key are of different types,
wherein for at least one accessibility option of the plurality of accessibility options in the first level of the hierarchy, a corresponding accessibility option of a same language is navigated to in the second level of the hierarchy.
12. The apparatus according to clause 11, wherein the plurality of accessibility options in the first level of the hierarchy are in different languages.
13. The apparatus according to clause 11, wherein the plurality of accessibility options in the second level of the hierarchy are in different languages.
14. The apparatus according to clause 11, wherein the circuitry is further configured to:
select, upon navigating to the second level of the hierarchy, an accessibility option in the second level of the hierarchy which is in the same language of the previously selected accessibility option in the first level of the hierarchy.
15. The apparatus according to clause 11, wherein the circuitry is further configured to:
return to the first level of the hierarchy to select an accessibility option of the same language in the first level when a press of first type is applied to the predetermined key at the second level of the hierarchy; and
cycle through the plurality of accessibility options in the first level of the hierarchy.
16. The apparatus according to clause 11, wherein the circuitry is further configured to:
cycle through the plurality of accessibility options in the second level when a press of first type is applied to the predetermined key at the second level of the hierarchy.
17. The apparatus according to clause 16, wherein the circuitry is further configured to:
return to the first level of the hierarchy to select an accessibility option of the same language in the first level when a press of second type is applied to the predetermined key at the second level of the hierarchy.
18. The apparatus according to any of clauses 11 to 17, wherein the plurality of accessibility options in the first level of the hierarchy are audio track options, and the plurality of accessibility options in the second level are audio description track options.
19. The apparatus according to any of clauses 11 to 17, wherein the plurality of accessibility options in the first level are subtitle options, and the plurality of accessibility options in the second level are specific subtitle options.

1. A method of providing a hierarchy of accessibility options for an apparatus, comprising the steps of:
cycling through a plurality of accessibility options in a first level of the hierarchy to select an accessibility option of a first type when receiving a signal indicating a first press of a predetermined key on a control device; and
navigating to a second level of the hierarchy to select an accessibility option of a second type when receiving a signal indicating a second press of the predetermined key,—the first press and the second press of the predetermined key are of different types,
wherein for at least one accessibility option of the plurality of accessibility options in the first level of the hierarchy, a corresponding accessibility option of a same language is navigated to in the second level of the hierarchy.

2. The method according to claim 1, wherein the plurality of accessibility options in the first level of the hierarchy are in different languages.

3. The method according to claim 1, wherein the plurality of accessibility options in the second level of the hierarchy are in different languages.

4. The method according to claim 1, further comprising the step of:
selecting, upon navigating to the second level of the hierarchy, an accessibility option in the second level of the hierarchy which is in the same language of the previously selected accessibility option in the first level of the hierarchy.

5. The method according to claim 1, further comprising the step of:
returning to the first level of the hierarchy to select an accessibility option of the same language in the first level when a press of first type is applied to the predetermined key at the second level of the hierarchy; and
cycling through the plurality of accessibility options in the first level of the hierarchy.

6. The method according to claim 1, further comprising the step of:
cycling through the plurality of accessibility options in the second level when a press of first type is applied to the predetermined key at the second level of the hierarchy.

7. The method according to claim 6, further comprising the step of:
returning to the first level of the hierarchy to select an accessibility option of the same language in the first level when a press of second type is applied to the predetermined key at the second level of the hierarchy.

8. The method according to claim 1, 7, wherein the plurality of accessibility options in the first level of the hierarchy are audio track options, and the plurality of accessibility options in the second level are audio description track options.

9. The method according to claim 1, 7, wherein the plurality of accessibility options in the first level are subtitle options, and the plurality of accessibility options in the second level are specific subtitle options.

10. A non-transitory computer readable medium storing a computer program product comprising computer readable instructions which, when loaded onto a computer, configure the computer to perform the method according to claim 1.

11. An apparatus, comprising circuitry configured to:
cycle through a plurality of accessibility options in a first level of the hierarchy to select an accessibility option of a first type when receiving a signal indicating a first press of a predetermined key on a control device; and
navigate to a second level of the hierarchy to select an accessibility option of a second type when receiving a signal indicating a second press of the predetermined key,—the first press and the second press of the predetermined key are of different types,
wherein for at least one accessibility option of the plurality of accessibility options in the first level of the hierarchy, a corresponding accessibility option of a same language is navigated to in the second level of the hierarchy.

12. The apparatus according to claim 11, wherein the plurality of accessibility options in the first level of the hierarchy are in different languages.

13. The apparatus according to claim 11, wherein the plurality of accessibility options in the second level of the hierarchy are in different languages.

14. The apparatus according to claim 11, wherein the circuitry is further configured to:
select, upon navigating to the second level of the hierarchy, an accessibility option in the second level of the hierarchy which is in the same language of the previously selected accessibility option in the first level of the hierarchy.

15. The apparatus according to claim 11, wherein the circuitry is further configured to:
return to the first level of the hierarchy to select an accessibility option of the same language in the first level when a press of first type is applied to the predetermined key at the second level of the hierarchy; and
cycle through the plurality of accessibility options in the first level of the hierarchy.

16. The apparatus according to claim 11, wherein the circuitry is further configured to:
cycle through the plurality of accessibility options in the second level when a press of first type is applied to the predetermined key at the second level of the hierarchy.

17. The apparatus according to claim 16, wherein the circuitry is further configured to:
return to the first level of the hierarchy to select an accessibility option of the same language in the first level when a press of second type is applied to the predetermined key at the second level of the hierarchy.

18. The apparatus according to claim 11, wherein the plurality of accessibility options in the first level of the hierarchy are audio track options, and the plurality of accessibility options in the second level are audio description track options.

19. The apparatus according to claim 11, wherein the plurality of accessibility options in the first level are subtitle options, and the plurality of accessibility options in the second level are specific subtitle options.
